(19) United States
(12) Patent Application Publication
(10) Pub. No.: US 2026/0249513 A1
(43) Pub. Date: Aug. 27, 2026

(54) CLASS A WOOD-BASED FIREPROOF BOARD AND ITS PREPARATION METHOD

(71) Applicant: Guizhou Jingmu Building Materials Co., Ltd., Guiyang (CN)

(72) Inventor: Fajiang CHEN, Guiyang (CN)

(73) Assignee: Guizhou Jingmu Building Materials Co., Ltd., Guiyang (CN)

(21) Appl. No.: 19/393,559

(22) Filed: Nov. 18, 2025

(30) Foreign Application Priority Data
Feb. 13, 2025 (CN) 202510158283.0

(51) Int. Cl. B27N 3/02; B27N 3/20; B27N 9/00

(52) U.S. Cl. CPC B27N 3/02; B27N 3/20; B27N 9/00

(57) ABSTRACT

A class A wood-based fireproof board and its preparation method are disclosed, which pertains to the technical field of fireproof board. The class A wood-based fireproof board, comprising the following mass percentage components: 20%-40% of light-burned magnesium oxide powder, 5%-30% of magnesium sulfate solution, 10%-30% of wood fiber, 20%-40% of inorganic filler, and 0.5%-1.5% of additive. The inorganic filler is an inorganic mineral filler with a specific gravity greater than 4, a mass ratio of the inorganic filler to the light-burned magnesium oxide is 1:0.8-1.2, and a particle size of the inorganic filler is equal to or greater than 2000 mesh. The class A wood-based fireproof board and its preparation method described in the present disclosure can solve the problem that the existing wood-based fireproof board is easy to crack and has poor fireproof performance.

### TECHNICAL FIELD

The present disclosure relates to the technical field of fireproof board, particularly a class A wood-based fireproof board and its preparation method.

### BACKGROUND

A wood-based fireproof board is a building material that is specially treated or composed to increase its fire resistance. The wood-based fireproof boards are commonly produced by physical or chemical means, such as impregnation, coating, or compositing, applied to the wood surface to raise its fire resistance rating. Nevertheless, the core material of the produced wood-based fireproof board remains wood, a limitation that results in relatively poor overall fire resistance.

The magnesium oxysulfide board is based on magnesium oxysulfide cement composed primarily of magnesium oxide, magnesium sulfate, and water, and a predetermined proportion of lightweight aggregates (e.g., perlite, expanded and vitrified small balls), reinforcing fibers (e.g., glass fibers, plant fibers), and functional additives are added. This mixture is processed through mixing, molding, and curing to form the final board. Notably, the magnesium oxysulfide board containing wood fiber exhibits excellent fire resistance. The higher the content of wood fiber in wood-based fireproof boards of magnesium oxysulfide boards, the higher the calorific value and the worse the fire resistance. In order to improve the fire resistance of wood-based fireproof boards, it is necessary to control the content of wood fiber. Nevertheless, reducing the content of wood fiber means increasing the content of magnesium oxide and brine, which leads to an increase in the reaction temperature, easily causing cracking of wood-based fireproof boards, and affecting the yield and fire performance of wood-based fireproof boards.

### SUMMARY

An objective of the present disclosure is to provide a class A wood-based fireproof board and its preparation method, to solve the problem that the existing wood-based fireproof board is easy to crack and has poor fireproof performance.

In order to achieve the above objective, the present disclosure provides a class A wood-based fireproof board, including the following mass percentage components: 20%-40% of light-burned magnesium oxide powder, 5%-30% of magnesium sulfate solution, 10%-30% of wood fiber, 20%-40% of inorganic filler, and 0.5%-1.5% of additive.

In some embodiments, a magnesium content in the light-burned magnesium oxide is 85 wt %-90 wt %, an activity is equal to or greater than 60%, and a calcium oxide content is less than 2 wt %.

In some embodiments, a Baume degree of the magnesium sulfate solution is 21-30.

In some embodiments, a particle size of the wood fiber is 40 mesh to 60 mesh.

In some embodiments, the inorganic filler is an inorganic mineral filler with a specific gravity greater than 4, a mass ratio of the inorganic filler to the light-burned magnesium oxide is 1:0.8-1.2, and a particle size of the inorganic filler is equal to or greater than 2000 mesh.

In some embodiments, the inorganic filler is one of barium sulfate and perovskite-type sulfate.

In some embodiments, the additive is 2%-4% by a mass of light-burned magnesium oxide, and the additive includes components of soluble sulfate, soluble phosphate, polyvinyl alcohol, cellulose ether and silicone oil in a mass percentage of 1:1:3:3:0.02.

A method for preparing the class A wood-based fireproof board, the method includes the following steps:

S1, adding the magnesium sulfate solution and the additive into a brine pool according to a mass percentage, and obtaining a brine solution via stirring uniformly;

S2, adding the wood fiber and the light-burned magnesium oxide powder into a first stirrer according to a mass percentage, adding brine solution into the first stirrer for a primary stirring, with a stirring time of 3 min to 8 min; after the primary stirring is finished, sending the mixture into a second stirrer for a secondary stirring;

S3, feeding the stirred raw materials in the second stirrer to a first forming machine and a second forming machine through a conveyor belt and a distributing belt respectively, feeding recovered backing plates into a loading rail via a first robotic arm, feeding the backing plates into a first conveyor through the loading rail, where the first forming machine and the second forming machine subsequently perform a two-stage forming process on the backing plates;

S4, sending the resulting board into a pre-pressing machine via the first conveyor for pre-pressing, and trimming via an edge trimming machine on the first conveyor; where the trimmed plates are transferred to a bottom mold under action of a second robotic arm for stacking plates, and a number of stacked plates is equal to or greater than 100;

S5, after the bottom mold stacking is completed, transferring them to a pressing machine through a second conveyor for molding in the press, and conveying the pressed plates into a curing conveying rail via the second conveyor and transporting them into a curing room for a primary curing;

S6, returning the plate and the bottom mold after the primary curing to the pressing machine via the curing conveying rail and the second conveyor for demolding, conveying the demolded plate and the bottom mold into a first plate separating machine via the second conveyor and the curing conveying rail for separating, where the first plate separating machine separates the plates and the backing plates, and the backing plate is stacked on one side of the first plate separating machine;

S7, conveying the separated bottom mold to a discharge end of the first conveyor via a first recovery rail and a second recovery rail for recycling;

S8, dispersing the backing plates one by one on a third conveyor under action of a second plate separating machine, cleaning the bottom plates via a cleaning machine arranged on the third conveyor, cooling via a cooling machine, shaping via a shaping machine, stacking, and then feeding into the loading rail through the first robotic arm for recycling; and

S9, transporting the separated plate to a cutting machine through the conveyor, cutting four sides via the cutting machine, and cutting the plate into two parts, after the plate is stacked by a plate stacking machine, performing a secondary curing at room temperature, and a secondary curing time is 7 days; after curing, baking, shaping and polishing the plate, and a surface error of the polished plate is equal to or less than 0.1 mm.

In some embodiments, in S3, the backing plate is a square aluminum plate having a side length equal to or greater than 2600 mm.

In some embodiments, in S5, pressure of the pressing machine is 11 MPa-15 MPa; a primary curing temperature of the curing room is 40° C.-60° C., and a primary curing time is 3 h-5 h.

The class A wood-based fireproof board and its preparation method, described in the present disclosure, have the following advantages and positive effects:
1. In the present disclosure, the content of wood fiber is reduced, which is beneficial to improving the fire resistance of the wood-based fireproof board, and makes the calorific value of the wood-based fireproof board meet the standard. The barium sulfate with high specific gravity and fine particle size is employed as a filler, to reduce the content of both magnesium sulfate and magnesium oxide, and the process reaction temperature, as well as to mitigate plate cracking, leading to improved plate yield and quality.
2. In the present disclosure, the additive can lubricate the internal structure of the board, and the sulfate radical ion in the additive can inhibit the alkali return and reduce the alkali return phenomenon of the plate. Through the absorption of carbon dioxide and sulfur dioxide, phosphate ions contribute to the formation of a passivation film on the board surface. This film wraps free magnesium oxide and magnesium sulfate, to improve the anti-aging performance and water resistance of the board, thereby assisting in increasing the strength of the board.
3. In the present disclosure, a wide aluminum plate serves as a backing plate, the aluminum plate exhibits good thermal conductivity, which can improve the uniformity of the temperature of the plate, promote the uniform reaction inside the board, make the internal reaction of the plate fully proceed, reduce the probability of the occurrence of the subsequent secondary reaction and reduce the deformation rate of the board.
4. A square wide backing plate with a large size is employed, and the area of the produced plate is large, which improves the stability of the plate stack, and the height of the stack can be increased by 30%-50%. Furthermore, after a single pressing operation, the resulting large plate can be divided into two plates, increasing production capacity by 160%-200%. This process achieves the automatic production of fireproof boards, thereby improving overall production efficiency.
5. In the present disclosure, the fireproof performance of the fireproof board reaches the national standard level A2 or above, and the static bending strength of the board reaches more than 28 MPa, and the internal bonding strength is more than 1.5 MPa. It exhibits excellent fireproof performance and strength, and can be used as a floor.

Further detailed descriptions of the technical scheme of the present disclosure can be found in the accompanying drawings and embodiments.

### BRIEF DESCRIPTION OF THE DRAWINGS

FIG. 1 is a process flow diagram of a wood-based fireproof board according to an embodiment of the present disclosure.

FIG. 2 is a production flow chart of wood-based fireproof board according to an embodiment of the present disclosure.

### REFERENCE NUMERALS IN FIGURES

1, a hopper; 2, a brine pool; 3, a first stirrer; 4, a second stirrer; 5, a conveyor belt; 6, a first forming machine; 7, a second forming machine; 8, a first conveyor; 9, a bottom mold; 10, a second conveyor; 11, a pressing machine; 12, a curing conveying rail; 13, a first plate separating machine; 14, a first recovery rail; 15, a second recovery rail; 16, a second plate separating machine; 17, a third conveyor; 18, a cutting machine; 19, a plate stacking machine; 20, a first robotic arm; 21, a second robotic arm; 22, a loading rail.

### DETAILED DESCRIPTION OF THE EMBODIMENTS

In the above description of the present disclosure, it is to be noted that the orientation or positional relationship indicated by terms “up”, “down”, “inner”, “outer”, etc. is based on the orientation or positional relationship shown in the accompanying drawings, or the orientation or positional relationship of a product conventionally placed during use, merely for ease of description and simplification of the description of the present disclosure, and not to indicate or imply that the referenced device or element must have a particular orientation and be constructed and operative in a particular orientation, and thus may not be construed as a limitation on the present disclosure. In the description of the present disclosure, it should be further noted that, unless otherwise explicitly specified and defined, the terms “arrangement”, “mounting” and “connection” should be understood in a broad sense, for example, they may be a fixed connection, a detachable connection, or an integrated connection; may be a mechanical connection, or an electrical connection; and may be a direct connection, or an indirect connection via an intermediate medium, or communication inside two elements. For those of ordinary skill in the art, the specific meanings of the above terms in the present disclosure may be understood according to specific circumstances.

In this application, unless otherwise defined herein, all technical and scientific terms used have the same meaning as commonly understood by one of ordinary skill in the art to which this application belongs. In case of conflict, the meaning as described in this specification or the meaning derived from the content recorded herein shall prevail. The terminology used herein is for the sole purpose of describing particular embodiments and is not intended to limit the application. To clearly describe the technical content of this application and facilitate an accurate understanding of the present disclosure, explanatory notes or definitions for terms used in this specification are provided prior to the description of specific embodiments.

The following is a detailed description of the embodiments of the present disclosure with reference to the accompanying drawings.

A class A wood-based fireproof board, including the following mass percentage components: 20%-40% of light-burned magnesium oxide powder, 5%-30% of magnesium sulfate solution, 10%-30% of wood fiber, 20%-40% of inorganic filler, and 0.5%-1.5% of additive.

Pigments can be added to the magnesium sulfate solution as required, with a mass percentage of 0.1%-0.5%.

The magnesium content in the light-burned magnesium oxide is 85 wt %-90 wt %, the activity is equal to or greater than 60%, and the calcium oxide content is less than 2 wt %.

The Baume degree of the magnesium sulfate solution is 21-30. The mass ratio of magnesium sulfate solution to magnesium oxide is 0.3-0.9:1.

The particle size of the wood fiber is 40 mesh to 60 mesh. The content of wood fiber in wood-based fireproof board is controlled below 30% to reduce the calorific value of wood-based fireproof board and improve the fireproof performance of wood-based fireproof board.

The inorganic filler is an inorganic mineral filler with a specific gravity greater than 4, the mass ratio of the inorganic filler to the light-burned magnesium oxide is 1:0.8-1.2, preferably 1:1. And the particle size of the inorganic filler is equal to or greater than 2000 mesh.

The inorganic filler is one of barium sulfate and perovskite-type sulfate, preferably barium sulfate. The barium sulfate with high specific gravity and fine particle size is employed as a filler, to reduce the content of both magnesium sulfate and magnesium oxide, and the process reaction temperature, as well as to mitigate plate cracking, leading to improved plate yield and quality. The selection of a high-specific-gravity, fine-particle-size barium sulfate filler serves to mitigate its impact on the properties of the wood-based fireproof board, thereby benefiting the enhancement of the board's fire resistance. The mass of barium sulfate, light-burned magnesium oxide and magnesium sulfate in the wood-based fireproof board shall be equal to or greater than 70% of the mass of the wood-based fireproof board.

The additive is 2%-4% by a mass of light-burned magnesium oxide, and the additive includes components of soluble sulfate, soluble phosphate, polyvinyl alcohol, cellulose ether and silicone oil in a mass percentage of 1:1:3:3:0.02. The additive can lubricate the internal structure of the board, and the sulfate radical ion in the additive can inhibit the alkali return and reduce the alkali return phenomenon of the plate. Through the absorption of carbon dioxide and sulfur dioxide, phosphate ions contribute to the formation of a passivation film on the board surface. This film wraps free magnesium oxide and magnesium sulfate, to improve the anti-aging performance and water resistance of the board, thereby assisting in increasing the strength of the board.

Soluble sulfate is a mixture of sodium sulfate, magnesium sulfate, potassium sulfate, copper sulfate and iron sulfate. Soluble phosphate is a mixture of one or more of sodium dihydrogen phosphate, disodium hydrogen phosphate, trisodium phosphate, potassium dihydrogen phosphate and dipotassium hydrogen phosphate.

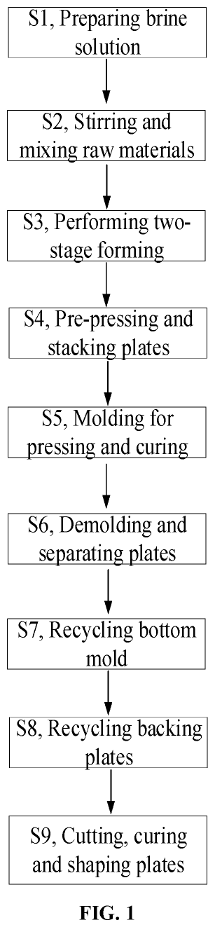

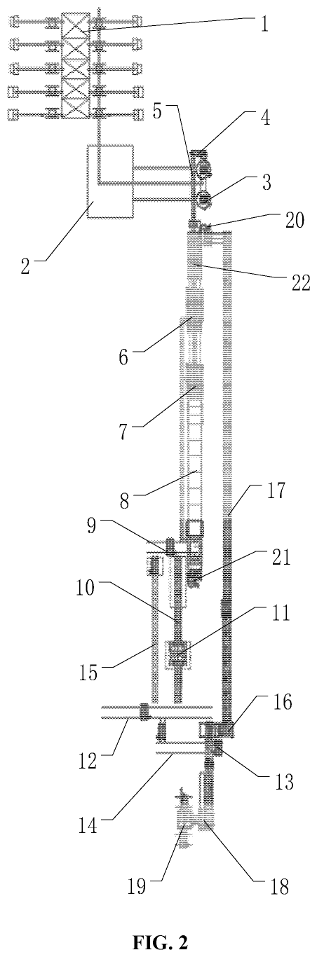

As shown in FIGS. 1-2, A method for preparing the class A wood-based fireproof board, the method includes the following steps:

S1, the magnesium sulfate solution and the additive are added into the brine pool 2 according to the mass percentage, and the brine solution is obtained via stirring uniformly;

S2, the wood fiber and the light-burned magnesium oxide powder are added into the first stirrer 3 according to the mass percentage, the brine solution is added into the first stirrer 3 for the primary stirring, with the stirring time of 3 min to 8 min. After the primary stirring is finished, the mixture is sent into the second stirrer 4 for the secondary stirring.

The first stirrer 3 is the planetary stirrer, which can stir at least 12,000 sheets of material per day, and the rotating belt revolution can effectively mix the materials, and the two stirrers are stirred in turn to ensure the feeding. The second stirrer 4 is the ring stirrer with a diameter of 100 cm and a rotating speed of 1200 rpm. As the second stirring, the agglomerates are dispersed to avoid the surface quality problems caused by impurities.

S3, the stirred raw materials in the second stirrer 4 is fed to the first forming machine 6 and the second forming machine 7 through the conveyor belt 5 and the distributing belt respectively, the recovered backing plates are fed into the loading rail 22 via the first robotic arm 20, the backing plates are fed into the first conveyor 8 through the loading rail 22, where the first forming machine 6 and the second forming machine 7 subsequently perform the two-stage forming process on the backing plates.

The backing plate is the square plate of 8-series aerospace aluminum alloy with a side length equal to or greater than 2600 mm. The wide aluminum plate serves as the backing plate. The aluminum plate exhibits good thermal conductivity, which can improve the uniformity of the temperature of the plate, promote the uniform reaction inside the board, make the internal reaction of the plate fully proceed, reduce the probability of the occurrence of the subsequent secondary reaction and reduce the deformation rate of the board.

The selected backing plate is a square, wide-format aluminum plate with a size of 2600 mm*2600 mm. The size of the backing plate is large and the area of the produced plate is large, which improves the stability of the plate stack. The height of the stack can be increased by 30%-50%. Furthermore, after a single pressing operation, the resulting large plate can be divided into two plates, and the production capacity is increased by 160%-200%. And the working frequency of the press 11 is reduced, which is beneficial to prolonging the service life of the pressing machine 11.

By employing the large backing plate, the edge trimming process omits the cuts on both sides of the middle section, thereby enhancing cutting efficiency and minimizing material waste. Two 50 mm*2600 mm edge strips are saved. The wasted cost of two raw materials is approximately CNY 5. In a production line with a daily capacity of 12,000 sheets, this saving accumulates to an annual total of CNY 18 million.

The forming width of the first forming machine 6 and the second forming machine 7 is 2600 mm*2600 mm, and there are 6 sweeping crescent roller tables inside. The crescent lifting angle is 10 degrees, and the forming roller tables are zigzag magnetic rollers. Uniform snowfall forming is adopted, and two forming machines are used to lay materials twice to ensure the uniformity of forming.

S4, the resulting board is sent into the pre-pressing machine via the first conveyor 8 for pre-pressing, and is trimmed via the edge trimming machine on the first conveyor 8, the excess forming materials after cutting can be recycled. Where the trimmed plates are transferred to the bottom mold 9 under action of the second robotic arm 21 for stacking plates, and the number of stacked plates is equal to or greater than 100.

S5, after the bottom mold 9 stacking is completed, them is transferred to the pressing machine 11 through the second conveyor 10 for molding in the press. The pressing machine 11 is a 10-cylinder 6500 -ton pressing machine with a width of 2800 mm*2800 mm, and the pressure of the pressing machine 11 is 11 MPa-15 MPa.

the pressed plates are conveyed into the curing conveying rail 12 via the second conveyor 10, and transported into the curing room for the primary curing. The primary curing temperature of the curing room is 40° C.-60° C., preferably 50° C. The curing time per cycle is 3 h-5 h, preferably 4h. Keeping the curing temperature at 50° C. can accelerate the reaction and reduce the demolding time.

S6, the plate and the bottom mold 9 after the primary curing are returned to the pressing machine 11 via the curing conveying rail 12 and the second conveyor 10 for demolding, the demolded plate and the bottom mold 9 are conveyed into the first plate separating machine 13 via the second conveyor 10 and the curing conveying rail 12 for separating, where the first plate separating machine 13 separates the plates and the backing plates, and the backing plate is stacked on one side of the first plate separating machine 13. The use of silicone oil as a release agent ensures easy separation of the plate from the backing plate.

S7, the separated bottom mold 9 is conveyed to the discharge end of the first conveyor 8 via the first recovery rail 14 and the second recovery rail 15 for recycling.

S8, the backing plates is dispersed one by one on the third conveyor 17 under action of the second plate separating machine 16, the bottom plates are cleaned via the cleaning machine arranged on the third conveyor 17, cooled via the cooling machine, shaped via the shaping machine, stacked, and then fed into the loading rail 22 through the first robotic arm 20 for recycling.

S9, the separated plate is transported to the cutting machine 18 through the conveyor, four sides are cut via the cutting machine 18, and the plate is cut into two parts, after the plate is stacked by the plate stacking machine 19, the secondary curing is performed at room temperature, and the secondary curing time is 7 days. After curing, the board is baked and shaped. The baking and shaping pressing machine operates at a pressure of 160 tons. The thickness of the hot pressing plate is 10 cm and features prismatic grooves on both upper and lower sides to facilitate water release. The baking temperature is 120° C.-130° C., and the baking time is 5 min to 12 min. This is followed by a polishing treatment, which employs a sequence of fixed-thickness planing, fine sanding, and surface fine-polishing to ensure the process is completed in a single pass. The surface error of the polished plate is equal to or less than 0.1 mm. Finally, the boards are stored after polishing.

### Embodiment 1

A class A wood-based fireproof board, including the following mass percentage components: 30% of light-burned magnesium oxide powder, 16% of magnesium sulfate solution, 23% of wood fiber, 30% of inorganic filler, and 1% of additive.

The Baume degree of the magnesium sulfate solution is 25.

The particle size of the wood fiber is 50 mesh.

The inorganic filler is barium sulfate, a particle size of the barium sulfate is 2500 mesh.

And the additive includes components of soluble sulfate, trisodium phosphate, polyvinyl alcohol, cellulose ether and silicone oil in a mass percentage of 1:1:3:3:0.02.

A method for preparing the class A wood-based fireproof board, the method includes the following steps:

S1, the magnesium sulfate solution and the additive are added into the brine pool 2 according to the mass percentage, and the brine solution is obtained via stirring uniformly.

S2, the wood fiber in the hopper 1 and the light-burned magnesium oxide powder are added into the planetary stirrer according to the mass percentage, the brine solution is added into the planetary stirrer for the primary stirring, with the stirring time of 5 min. After the primary stirring is finished, the mixture is sent into the ring stirrer for the secondary stirring.

S3, the stirred raw materials in the ring stirrer is fed to the first forming machine 6 and the second forming machine 7 through the conveyor belt 5 and the distributing belt respectively, the recovered backing plates are fed into the loading rail 22 via the first robotic arm 20, the backing plates are fed into the first conveyor 8 through the loading rail 22, where the first forming machine 6 and the second forming machine 7 subsequently perform the two-stage forming process on the backing plates. The backing plate is a square aluminum plate of 2600 mm*2600 mm.

S4, the resulting board is sent into the pre-pressing machine via the first conveyor 8 for pre-pressing, and is trimmed via the edge trimming machine on the first conveyor 8. Where the trimmed plates are transferred to the bottom mold 9 under action of the second robotic arm 21 for stacking plates, and the number of stacked plates is 130.

S5, after the bottom mold 9 stacking is completed, them is transferred to the pressing machine 11 through the second conveyor 10 for molding in the press. The pressure of the pressing machine 11 is 11 MPa-15 MPa. The pressed plates are conveyed into the curing conveying rail 12 via the second conveyor 10, and transported into the curing room for the primary curing. The primary curing temperature is 50° C., and the curing time per cycle is 4 h.

S6, the plate and the bottom mold 9 after the primary curing are returned to the pressing machine 11 via the curing conveying rail 12 and the second conveyor 10 for demolding, the demolded plate and the bottom mold 9 are conveyed into the first plate separating machine 13 via the second conveyor 10 and the curing conveying rail 12 for separating, where the first plate separating machine 13 separates the plates and the backing plates, and the backing plate is stacked on one side of the first plate separating machine 13.

S7, the separated bottom mold 9 is conveyed to the discharge end of the first conveyor 8 via the first recovery rail 14 and the second recovery rail 15 for recycling.

S8, the backing plates is dispersed one by one on the third conveyor 17 under action of the second plate separating machine 16, the bottom plates are cleaned via the cleaning machine arranged on the third conveyor 17, cooled via the cooling machine, shaped via the shaping machine, stacked, and then fed into the loading rail 22 through the first robotic arm 20 for recycling.

S9, the separated plate is transported to the cutting machine 18 through the conveyor, cut four sides via the cutting machine 18, and the plate is cut into two parts, after the plate is stacked by the plate stacking machine 19, the secondary curing is performed at room temperature, and the secondary curing time is 7 days. After curing, the board is baked and shaped. This is followed by a polishing treatment. The surface error of the polished plate is equal to or less than 0.1 mm.

The fire resistance and mechanical properties of the obtained plate are tested. The fire resistance rating of the plate reached the A1 level of the national standard, the static bending strength of the plate is 30 MPa, and the internal bonding strength of the plate is 2.2 MPa.

### Embodiment 2

A class A wood-based fireproof board, including the following mass percentage components: 32% of light-burned magnesium oxide powder, 18% of magnesium sulfate solution, 19% of wood fiber, 30% of inorganic filler, and 1% of additive.

The Baume degree of the magnesium sulfate solution is 28.

The particle size of the wood fiber is 60 mesh.

The inorganic filler is barium sulfate, a particle size of the barium sulfate is 2000 mesh.

And the additive includes components of potassium sulfate, potassium dihydrogen phosphate, polyvinyl alcohol, cellulose ether and silicone oil in a mass percentage of 1:1:3:3:0.02.

The preparation method of class A wood-based fireproof board is the same as that of embodiment 1.

The fire resistance and mechanical properties of the obtained plate are tested. The fire resistance rating of the plate reached the A1 level of the national standard, the static bending strength of the plate is 33 MPa, and the internal bonding strength of the plate is 2.5 MPa.

### Embodiment 3

A class A wood-based fireproof board, including the following mass percentage components: 26% of light-burned magnesium oxide powder, 23% of magnesium sulfate solution, 25% of wood fiber, 25% of inorganic filler, and 1% of additive.

The Baume degree of the magnesium sulfate solution is 25.

The particle size of the wood fiber is 50 mesh.

The inorganic filler is barium sulfate, a particle size of the barium sulfate is 2500 mesh.

And the additive includes components of soluble sulfate, soluble phosphate, polyvinyl alcohol, cellulose ether and silicone oil in a mass percentage of 1:1:3:3:0.02.

Soluble sulfate is a mixture of sodium sulfate and potassium sulfate with a mass ratio of 1:1, and soluble phosphate is a mixture of sodium dihydrogen phosphate and trisodium phosphate with a mass ratio of 1:1.

The preparation method of class A wood-based fireproof board is the same as that of embodiment 1.

The fire resistance and mechanical properties of the obtained plate are tested. The fire resistance rating of the plate reached the A2 level of the national standard, the static bending strength of the plate is 29 MPa, and the internal bonding strength of the plate is 1.8 MPa.

Therefore, the class A wood-based fireproof board and its preparation method are provided, which can solve the problem that the existing wood-based fireproof board is easy to crack and has poor fireproof performance.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A class A wood-based fireproof board, comprising the following components by mass percent: 20%-40% of light-burned magnesium oxide powder, 5%-30% of magnesium sulfate solution, 10%-30% of wood fiber, 20%-40% of inorganic filler, and 0.5%-1.5% of additive;
wherein the inorganic filler is an inorganic mineral filler with a specific gravity greater than 4, a mass ratio of the inorganic filler to the light-burned magnesium oxide is 1:0.8-1.2, and a particle size of the inorganic filler is equal to or greater than 2000 mesh;
wherein the additive is 2%-4% by a mass of light-burned magnesium oxide, and the additive comprises components of soluble sulfate, soluble phosphate, polyvinyl alcohol, cellulose ether and silicone oil in a mass percentage of 1:1:3:3:0.02.

2. The class A wood-based fireproof board according to claim 1, wherein a magnesium content in the light-burned magnesium oxide is 85 wt %-90 wt %, an activity is equal to or greater than 60%, and a calcium oxide content is less than 2 wt %.

3. The class A wood-based fireproof board according to claim 1, wherein a Baume degree of the magnesium sulfate solution is 21-30.

4. The class A wood-based fireproof board according to claim 1, wherein a particle size of the wood fiber is 40 mesh to 60 mesh.

5. The class A wood-based fireproof board according to claim 1, wherein the inorganic filler is one of barium sulfate and perovskite-type sulfate.

6. A method for preparing the class A wood-based fireproof board according to claim 1, wherein the method comprises the following steps:
S1, adding the magnesium sulfate solution and the additive into a brine pool according to a mass percentage, and obtaining a brine solution via stirring uniformly;
S2, adding the wood fiber and the light-burned magnesium oxide powder into a first stirrer according to a mass percentage, adding brine solution into the first stirrer for a primary stirring, with a stirring time of 3 min to 8 min; after the primary stirring is finished, sending the mixture into a second stirrer for a secondary stirring;
S3, feeding the stirred raw materials in the second stirrer to a first forming machine and a second forming machine through a conveyor belt and a distributing belt respectively, feeding recovered backing plates into a loading rail via a first robotic arm, and feeding the backing plates into a first conveyor through the loading rail, wherein the first forming machine and the second forming machine subsequently perform a two-stage forming process on the backing plates;
S4, sending the resulting board into a pre-pressing machine via the first conveyor for pre-pressing, and trimming via an edge trimming machine on the first conveyor; wherein the trimmed plates are transferred to a bottom mold under action of a second robotic arm for stacking plates, wherein a number of stacked plates is equal to or greater than 100;
S5, after the bottom mold stacking is completed, transferring them to a pressing machine through a second conveyor for molding in the press, and conveying the pressed plates into a curing conveying rail via the second conveyor and transporting them into a curing room for a primary curing;
S6, returning the plate and the bottom mold after the primary curing to the pressing machine via the curing conveying rail and the second conveyor for demolding, and conveying the demolded plate and the bottom mold into a first plate separating machine via the second conveyor and the curing conveying rail for separating, wherein the first plate separating machine separates the plates and the backing plates, and the backing plate is stacked on one side of the first plate separating machine;
S7, conveying the separated bottom mold to a discharge end of the first conveyor via a first recovery rail and a second recovery rail for recycling;
S8, dispersing the backing plates one by one on a third conveyor under action of a second plate separating machine, cleaning the bottom plates via a cleaning machine arranged on the third conveyor, cooling via a cooling machine, shaping via a shaping machine, stacking, and then feeding into the loading rail through the first robotic arm for recycling; and
S9, transporting the separated plate to a cutting machine through the conveyor, cutting four sides via the cutting machine, and cutting the plate into two parts; and, after the plate is stacked by a plate stacking machine, performing a secondary curing at room temperature, wherein a secondary curing time is 7 days; and after curing, baking, shaping and polishing the plate, a surface error of the polished plate is equal to or less than 0.1 mm;
wherein in S3, the backing plate is a square aluminum plate having a side length of equal to or greater than 2600 mm;
wherein in S5, a pressure of the pressing machine is 11 MPa-15 MPa; a primary curing temperature of the curing room is 40° C.-60° C., and a primary curing time is 3 h-5 h.
